(19) United States
(12) Patent Application Publication
(10) Pub. No.: US 2022/0105619 A1
(43) Pub. Date: Apr. 7, 2022

(54) TOOL FOR CUTTING JOINT OF MASONRY WALL

(71) Applicant: MOJEON INDUSTRIAL. CO., LTD., Gyeonggi-do (KR)

(72) Inventor: Yan Sup LEE, Seoul (KR)

(21) Appl. No.: 17/495,305

(22) Filed: Oct. 6, 2021

(30) Foreign Application Priority Data
Oct. 6, 2020 (KR) 10-2020-0128526

(51) Int. Cl. B25D 17/08; E04F 21/00; B25D 17/02

(52) U.S. Cl. CPC B25D 17/08; B25D 2250/351; B25D 17/02; E04F 21/00

(57) ABSTRACT

A tool for cutting joints of a masonry wall includes a cutter shank connected to an output end of an electric motor to receive vibration, a joint cutter separably coupled at a rear end thereof to the cutter shank, having a cross-section, which has a cutter thickness that is the same as or smaller than a thickness of the joints and a height that is several times larger than the cutter thickness, and having cutter grooves longitudinally formed on both sides in the direction of the cutter thickness to perform cutting and discharge chips of cut joints, thereby showing a cutting ability, a connection socket passed over the joint cutter to be positioned at a coupling portion between the cutter shank and the joint cutter, and a coupling pin inserted in the connection socket and keeping the cutter shank and the joint cutter coupled to each other.

### CROSS REFERENCE

The present application claims priority to Korean Patent Application No. 10-2020-0128526, filed Oct. 6, 2020, the entire contents of which is incorporated herein for all purposes by this reference.

### BACKGROUND

The present disclosure relates to a tool for cutting joints on a masonry wall. In particular, the present disclosure relates to a tool cutting joints on a masonry wall, the tool being able to improve a cutting speed, minimize shock on a masonry wall, and reduce cutting resistance due to the inclined cutting faces of cutters by smoothly discharging chips when cutting joints, and that enables cutters to be replaced when the cutters are shortened due to long-time use.

In structures made of bricks, a masonry veneer wall, which a non-bearing wall, is constructed by combining bricks or blocks stacked mortar that forms joints. These joints are changed in color, cracked, or the like due to aging by weathering after construction, so they have to be replaced. Replacing joints is required even to provide the waterproof and water-repellent function and the bonding function of joints, and cutting tools are used for this work.

When a masonry wall is constructed on the outer surface of an interior wall, the stacked bricks come apart or destroy due to an earthquake, shock, or wind pressure. Accordingly, quake-resistant and reinforcing plans that can prevent a fall and destruction by keeping the stacked bricks firmly combined with the interior wall have been developed. As an example of reinforcing a masonry wall, a method of installing reinforcement pins or deformed wires in joints has been known. When joints are replaced, or reinforcing pins or deformed wires are added to joints due to weathering or in order to improve their function, cutting (digging) of joints should be performed first, and for this purpose, cutting tools are used.

Existing cutting tools, which are members made of steel materials, have a problem that when they are used for a long period of time, the cutting blades are not only blunted, but worn and the length is reduced, so they have to be discarded. Further, cutting resistance is large and large shock is applied to a masonry wall in cutting, so the work noise is loud and there is a possibility of cracking.

As one of the background of the present disclosure, there is Korean Patent No. 10-0623206, titled ‘Mortar breaking tool’. This invention makes it possible to safely break joints without damage to surrounding whole bricks when breaking joints to repair or replace bricks at a damaged part. However, this invention has a defect that the chips produced when joints are cut are not smoothly discharged, so the cutting resistance increases.
Patent Document: Korean Patent No. 10-0623206

### SUMMARY OF THE INVENTION

An objective of the present disclosure is to provide a tool for cutting joints of a masonry wall, the tool being able to improve a cutting speed, minimize shock on a masonry wall, and reduce cutting resistance due to the inclined cutting face of a cutter by smoothly discharging chips when cutting joints, and that enables a cutter to be replaced when the cutter is shortened due to long-time use.

A tool for cutting joints of a masonry wall according to an embodiment of the present disclosure includes: a cutter shank connected to an output end of an electric motor to receive vibration; a joint cutter separably coupled at a rear end thereof to the cutter shank, having a cross-section, which has a cutter thickness that is the same as or smaller than a thickness of the joints and a height that is several times larger than the cutter thickness, and having cutter grooves longitudinally formed on both sides in the direction of the cutter thickness to perform cutting and discharge chips of cut joints, thereby showing a cutting ability; a connection socket passed over the joint cutter to be positioned at a coupling portion between the cutter shank and the joint cutter; and a coupling pin inserted in the connection socket and keeping the cutter shank and the joint cutter coupled to each other.

A tool for cutting joints of a masonry wall according to another embodiment of the present disclosure includes: a cutter shank connected to an output end of an electric motor to receive vibration; and a joint cutter integrally elongated from the cutter shank, having a cross-section, which has a cutter thickness that is the same as or smaller than a thickness of the joints and a height that is several times larger than the cutter thickness, and having cutter grooves longitudinally formed on both sides in the direction of the cutter thickness to perform cutting and discharge chips, thereby showing a cutting ability.

The cutter shank may have: an electric motor connection shaft at an end that is connected to the electric motor; a joint cutter connection shaft at another end that is formed coaxially with the electric motor connection shaft, is larger in diameter than the electric motor connection shaft, and has a slot in which the joint cutter is inserted; and a shank pin hole in which the coupling pin is fitted through the slot of the joint cutter connection shaft.

The joint cutter may be made of special steel or alloy steel.

The joint cutter may have a cutting face formed at a front end thereof and having a predetermined cutting angle to reduce cutting resistance.

The cutting angle may be an acute angle.

The cutting angle may be a right angle.

The connection socket may be formed in a cylindrical shape and may have a joint cutter connection shaft-coupling hole in which a joint cutter connection shaft is inserted, and a socket pin hole in which the coupling pin is fitted.

The cutter grooves may be formed to have a minimum cutter groove rib thickness at alternate positions with a symmetric axis of a cross-section therebetween.

A groove depth of the cutter grooves may be determined such that the cutter grooves are formed deeper than the symmetric axis within a range that a minimum cutter groove rib thickness allows.

The cutter grooves may have any one shape of a semicircle, a semi-ellipse, a trapezoid, and a triangle.

According to a tool for cutting joints of a masonry wall of the present disclosure, cutting resistance is decreased by the cutter grooves formed at the joint cutter, so not only shock that is applied to a masonry wall is minimized, but cutting speed is improved by smoothly discharging chips.

Further, it is possible to reduce cutting resistance due to the inclined cutting face of the cutter.

Further, there is an advantage that when the joint cutter is shortened due to long-time use, the joint cutter can be replaced with new one.

Further, since the cutter grooves are formed deep and alternately with the symmetric axis of the cross-section of the joint cutter therebetween, the cutting ability is excellent and the lifespan of the joint cutter is increased.

### BRIEF DESCRIPTION OF THE DRAWINGS

The accompanying drawings of this specification exemplify preferred embodiments and help easy understanding of the present disclosure together with the following detailed description, so the present disclosure should not be construed as being limited to the drawings.

FIG. 1 is a perspective view of a tool for cutting joints of an assembly type masonry wall according to a first embodiment of the present disclosure;

FIG. 2 is an exploded perspective view of FIG. 1;

FIG. 3 is a front view of FIG. 1;

FIGS. 4A to 4D are enlarged cross-sectional views taken along line A-A shown in FIG. 3 to show the shapes of cutter grooves of various cutters;

FIG. 5 is a view showing a use state of a tool for cutting joints of a masonry wall according to an embodiment of the present disclosure;

FIG. 6A is a perspective view of a tool for cutting joints of an integration type masonry wall according to a second embodiment of the present disclosure;

FIG. 6B is a front view of FIG. 6A;

FIG. 7A is a front view of a modification of the tool for cutting joints of an assembly type masonry wall according to the first embodiment of the present disclosure; and

FIG. 7B is a front view of a modification of the tool for cutting joints of an assembly type masonry wall according to the second embodiment of the present disclosure.

### DETAILED DESCRIPTION OF THE INVENTION

The present disclosure are described hereafter in detail with reference to the embodiments proposed in the accompanying drawings, but the proposed embodiments are provided as examples for clear understanding of the present disclosure and the present disclosure is not limited thereto.

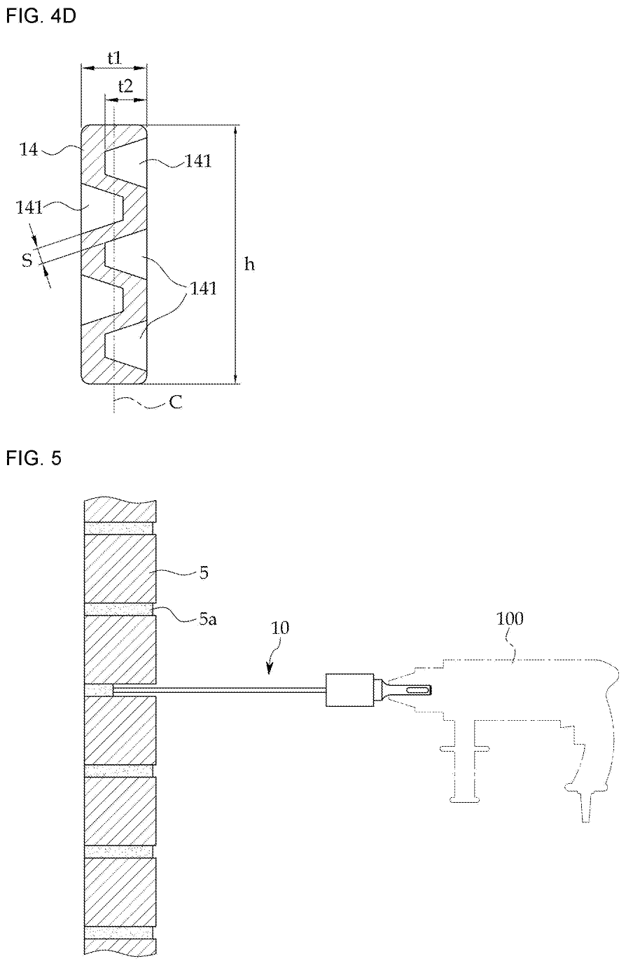

A tool 10 for cutting joints of a masonry wall of the present disclosure is, as shown in FIG. 5, a tool that is connected to an electric motor 100 in use to cut (dig) joints 5a formed in a masonry wall by a predetermined depth. The tool 10 for cutting joints of a masonry wall may be used at a predetermined angle.

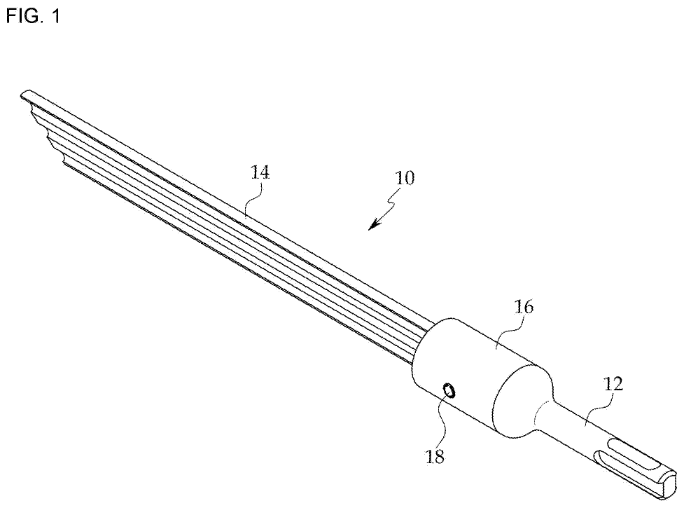

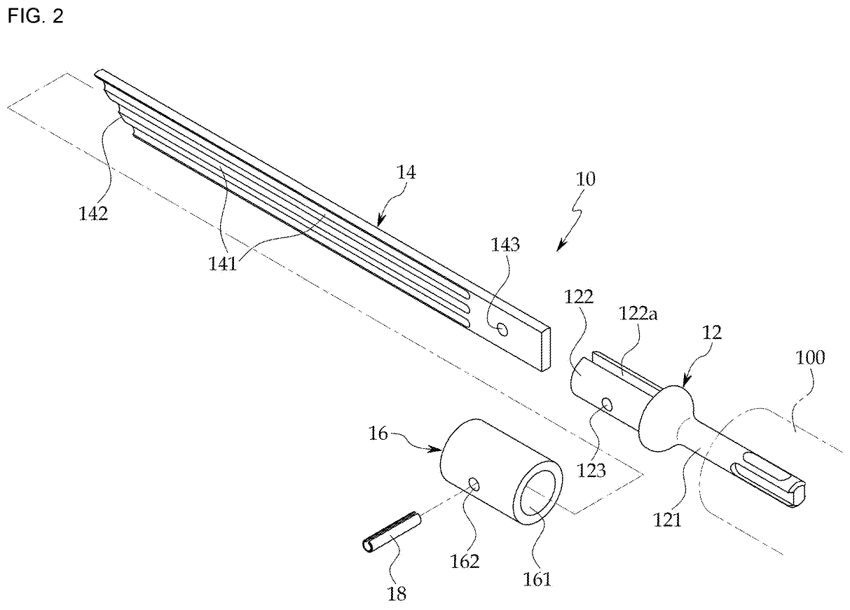

The tool 10 for cutting joints of a masonry wall according to the first embodiment is configured to be manufactured in an assembly type, as shown in FIGS. 1 to 4D. As shown in FIGS. 1 to 4D, the tool 10 for cutting joints of a masonry wall includes: a cutter shank 12 that is connected to the output end of an electric motor 100 through a chuck to receive vibration; a joint cutter 14 that is separably coupled at the rear end to the cutter shank 12; a connection socket 16 that is passed over the joint cutter 14 to be positioned at the coupling portion between the cutter shank 12 and the joint cutter 14; and a coupling pin 18 that is inserted in the connection socket 16 and keeps the cutter shank 12 and the joint cutter 14 coupled to each other.

The electric motor 100, which is well known in the art, generates vibration at the output end and is not described in detail herein.

The cutter shank 12 may be made of a steel material. The cutter shank 12 has: an electric motor connection shaft 121 at an end that is connected to the electric motor 100; a joint cutter connection shaft 122 at another end that is formed coaxially with the electric motor connection shaft 121, is larger in diameter than the electric motor connection shaft 121, and has a slot 122a in which the joint cutter 14 is inserted; and a shank pin hole 123 in which the coupling pin 18 is fitted through the slot 122a of the joint cutter connection shaft 122. Accordingly, the cutter shank 12 is connected to the output end of the electric motor 100 and axially generates vibration.

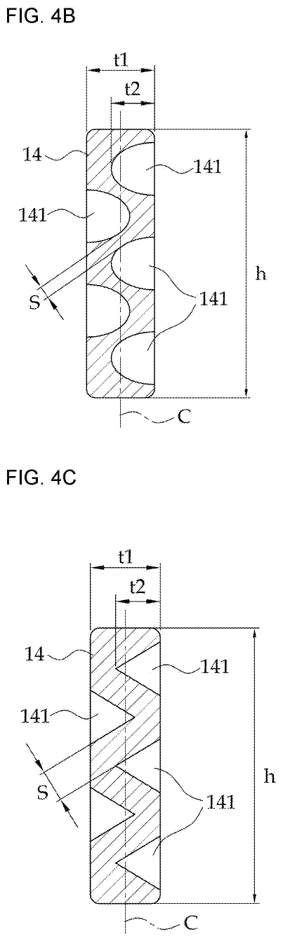

The joint cutter 14 may be made of special steel or alloy steel to maintain a high cutting ability. As shown in FIG. 4A, the joint cutter 14 has a substantially rectangular cross-section having a cutter thickness t1, which is the same as or smaller than the thickness T of a joint 5a, and a height h that is several times larger than the cutter thickness t1. The joint cutter 14 has cutter grooves 141 that are formed on both sides in the direction of the cutter thickness t1, are longitudinally alternately positioned with a symmetric axis C of the cross-section therebetween, perform cutting, and discharge chips of joints.

The groove depth t2 of the cutter grooves 141 may be determined such that the cutter grooves 141 are formed deeper than the symmetric axis C within a range that a minimum cutter groove rib thickness S allows, and in this case, it is possible to increase the cutting ability and improve the lifespan of the joint cutter 14. The minimum cutter groove rib thickness S is the minimum gap between cutter grooves 141 that are selected from both sides, respectively, and are closest to each other. The cutter grooves 141, as shown in FIGS. 4A to 4D, may have any one shape of a semicircle, a semi-ellipse, a trapezoid, and a triangle.

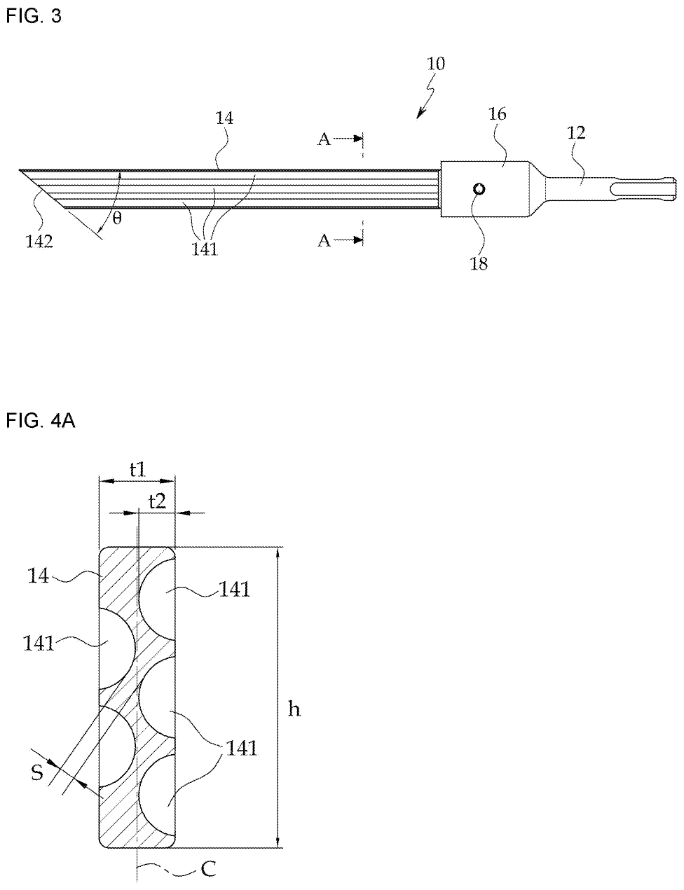

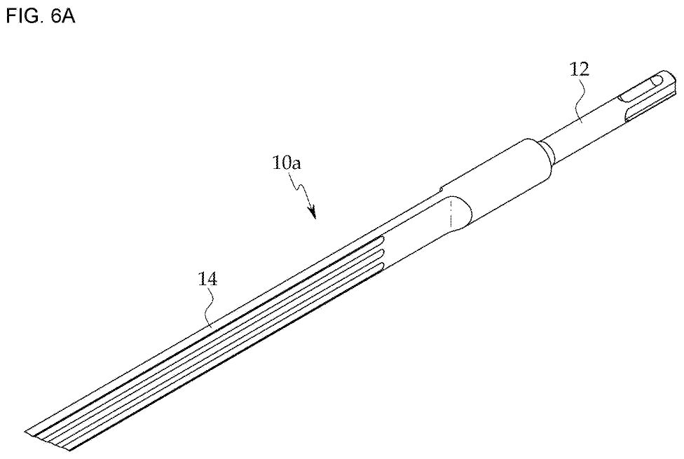

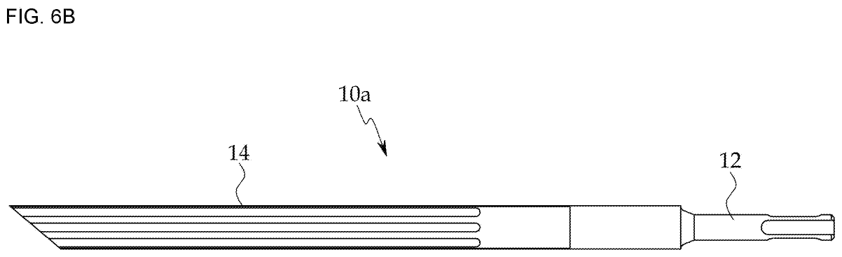

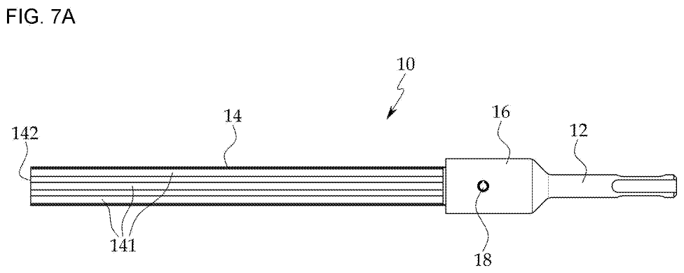

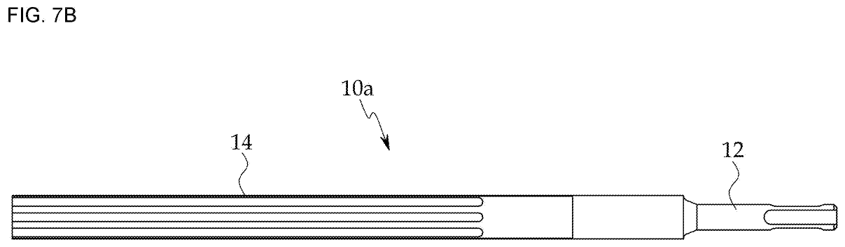

A cutter pin hole 143 for coupling the coupling pin 18 is formed at the rear end portion of the joint cutter 14. Accordingly, the chips that are produced when the joint cutter 14 cuts joints are smoothly discharged through the cutter grooves 141. The joint cutter 14 may have a cutting face 142 formed at the front end thereof and having a predetermined cutting angle θ to reduce cutting resistance. The cutting angle θ may be an acute angle, as shown in FIGS. 3 and 6B, or may be a right angle, as shown in FIGS. 7A and 7B. When the cutting angle θ is an acute angle, the cutting face 142 is inclined, thereby being able to further reduce cutting resistance of the joint cutter 14.

The connection socket 16 is formed in a cylindrical shape and has a joint cutter connection shaft-coupling hole 161 in which the joint cutter connection shaft 122 is inserted, and a socket pin hole 162 in which the coupling pin 18 is fitted. The length of the connection socket 16 is the same as the length of the joint cutter connection shaft 122.

A method of assembling the tool 10 for cutting joints of an assembly type masonry wall which has the configuration described above is described hereafter.

First, the rear end of the joint cutter 14 is inserted into the slot 122a of the cutter shank 12 such that the shank pin hole 123 and the cutter pin hole 143 are positioned on the same axis.

Next, the connection socket 15 is passed over the joint cutter 14 to be positioned at the joint cutter connection shaft 122 of the cutter shank 12, and then the socket pin hole 162 is positioned on the same axis as the shank pin hole 123.

Next, the coupling pin 18 is fitted into the socket pin hole 162, the shank pin hole 123, and the cutter pin hole 143 that are positioned on the same axis, whereby the joint cutter 14 is coupled fastened to the cutter shank 12 by the connection socket 16 and the coupling pin 18 and the tool 10 for cutting joints of a masonry wall is assembled.

The tool 10 for cutting joints of a masonry wall which is assembled in this way can perform cutting at an angle of about 45°. Since the joint cutter 14 has the cutter grooves 141, chips are smoothly discharged through the cutter grooves 141 when the joints 5a are cut, as shown in FIG. 5, so cutting efficiency is improved. Further, the cutter grooves 141 minimize shock that is applied to the masonry wall and reduce cutting noise in cutting. In particular, since a plurality of cutter grooves 141 is formed in the height direction of a cross-section and are alternately arranged on both sides, even if cutting depth is large, chips keep being easily discharged, so the cutting ability is excellent. Further, since the cutting face 142 of the joint cutter 14 is a sharp cutting face, cutting resistance can be reduced even if a cutting depth is large.

The tool 10 for cutting joints of a masonry wall has an advantage that cutting resistance can be reduced by the cutting angle θ of the joint cutter 14. Further, it has an advantage that when the joint cutter 14 decreases in length due to long-period of time, it is possible to keep using the tool by removing and replacing the shortened joint cutter 14 with a new one in the reverse order of assembly.

A tool 10a for cutting joints of a masonry wall according to a second embodiment of the present disclosure is configured in an integrated type, as shown in FIGS. 6A and 6B. As shown in FIGS. 6A and 6B, the tool 10a is composed of a cutter shank 12 connected to the output end of an electric motor 100 and receiving vibration, and a joint cutter 14 integrally elongated from the cutter shank 12. The joint cutter 14 has cutter grooves 141 that are the same as those of the first embodiment, so it is not described in detail. In this embodiment, the tool 10a for cutting joints of a masonry wall may be made of carbon steel, special steel, alloy steel, or the like to increase the rigidity and strength of the joint cutter 14.

According to the integration type tool 10a for cutting joints of a masonry wall, it is impossible to replace only the joint cutter 14, but it has various cutter grooves 141 shown in FIGS. 4A to 4D, so there is an advantage that chips can be smoothly discharged, the cutting ability is excellent, and shock that is applied to a masonry wall in cutting can be minimized.

Although the present disclosure was described in detail with reference to embodiments, the present disclosure may be changed and modified in various ways by those skilled in the art without departing from the scope of the present disclosure. The present disclosure is not limited to those changes and modifications and is limited only the following claims.

What is claimed is:

1. A tool for cutting joints of a masonry wall which is connected to an electric motor to cut joints in a masonry wall by a predetermined depth, the tool comprising:
a cutter shank connected to an output end of the electric motor to receive vibration;
a joint cutter separably coupled at a rear end thereof to the cutter shank, having a cross-section, which has a cutter thickness that is the same as or smaller than a thickness of the joints and a height that is several times larger than the cutter thickness, and having cutter grooves longitudinally formed on both sides in the direction of the cutter thickness to perform cutting and discharge chips of cut joints, thereby showing a cutting ability;
a connection socket passed over the joint cutter to be positioned at a coupling portion between the cutter shank and the joint cutter; and
a coupling pin inserted in the connection socket and keeping the cutter shank and the joint cutter coupled to each other.

2. A tool for cutting joints of a masonry wall which is connected to an electric motor to cut joints in a masonry wall by a predetermined depth, the tool comprising:
a cutter shank connected to an output end of the electric motor to receive vibration; and
a joint cutter integrally elongated from the cutter shank, having a cross-section, which has a cutter thickness that is the same as or smaller than a thickness of the joints and a height that is several times larger than the cutter thickness, and having cutter grooves longitudinally formed on both sides in the direction of the cutter thickness to perform cutting and discharge chips, thereby showing a cutting ability.

3. The tool of claim 1, wherein the cutter shank has: an electric motor connection shaft at an end that is connected to the electric motor; a joint cutter connection shaft at another end that is formed coaxially with the electric motor connection shaft, is larger in diameter than the electric motor connection shaft, and has a slot in which the joint cutter is inserted; and a shank pin hole in which the coupling pin is fitted through the slot of the joint cutter connection shaft.

4. The tool of claim 1, wherein the joint cutter has a cutting face formed at a front end thereof and having a predetermined cutting angle to reduce cutting resistance.

5. The tool of claim 2, wherein the joint cutter has a cutting face formed at a front end thereof and having a predetermined cutting angle to reduce cutting resistance.

6. The tool of claim 1, wherein the cutting angle is an acute angle.

7. The tool of claim 1, wherein the cutting angle is a right angle.

8. The tool of claim 1, wherein the connection socket is formed in a cylindrical shape and has a joint cutter connection shaft-coupling hole in which a joint cutter connection shaft is inserted, and a socket pin hole in which the coupling pin is fitted.

9. The tool of claim 1, wherein the cutter grooves are formed to have a minimum cutter groove rib thickness at alternate positions with a symmetric axis of a cross-section therebetween.

10. The tool of claim 2, wherein the cutter grooves are formed to have a minimum cutter groove rib thickness at alternate positions with a symmetric axis of a cross-section therebetween.

11. The tool of claim 9, wherein a groove depth of the cutter grooves is determined such that the cutter grooves are formed deeper than the symmetric axis within a range that a minimum cutter groove rib thickness allows.

12. The tool of claim 10, wherein a groove depth of the cutter grooves is determined such that the cutter grooves are formed deeper than the symmetric axis within a range that a minimum cutter groove rib thickness allows.

13. The tool of claim 1, wherein the cutter grooves have any one shape of a semicircle, a semi-ellipse, a trapezoid, and a triangle.

14. The tool of claim 2, wherein the cutter grooves have any one shape of a semicircle, a semi-ellipse, a trapezoid, and a triangle.
